(19) United States
(12) Patent Application Publication
(10) Pub. No.: US 2003/0224273 A1
(43) Pub. Date: Dec. 4, 2003

(54) Developer, developer cartridge, and image forming apparatus

(76) Inventors: Kenji Koido, Tokyo (JP); Toru Ishihara, Tokyo (JP)

Correspondence Address: RABIN & CHAMPAGNE, PC, 1101 14TH STREET, NW, SUITE 500, WASHINGTON, DC, 20005, US

(21) Appl. No.: 10/445,203

(22) Filed: May 27, 2003

(30) Foreign Application Priority Data
May 27, 2002 (JP) 2002-152151

(51) Int. Cl. G03G 9/09

(52) U.S. Cl. 430/108.1; 430/108.4

(57) ABSTRACT

A developer contains a resin material, a colorant, and a lubricant. The ratio of a weight part of the lubricant to a weight part of the colorant is in the range of 0.3 to 10.0. The colorant has a mean particle diameter in the range of 20 to 50 nm and a mean aggregate diameter in the range of 20 to 600 nm. The ratio of the weight of the lubricant to the weight of the colorant may be in the range of 0.5 to 5.0. An image forming apparatus incorporates the developer cartridge that holds the developer.

### BACKGROUND OF THE INVENTION

1. Field of the Invention

The present invention relates to a developer, a developer cartridge, and an image-forming apparatus.

2. Description of the Related Art

A conventional electrophotographic image-forming apparatus performs an electrophotographic process: charging, exposing, developing, transferring and fixing. A charging roller charges uniformly the surface of a photoconductive drum made of a photoconductive material. An exposing unit such as an LED head illuminates the charged surface of the photoconductive drum to form an electrostatic latent image thereon. Then, a developing roller applies toner to the electrostatic latent image to develop the electrostatic latent image into a toner image. The toner image is transferred onto print paper. The print paper that carries an toner image thereon is advanced to a fixing unit that heats the toner image under pressure to permanently fix the toner image on the paper. Thus, the fixing unit includes a heat roller for heating the toner image and a pressure roller for pressurizing the toner image.

The toner for use in an electrophotographic image-forming apparatus is manufactured as follows:

A blend of a thermoplastic resin material and a coloring agent such as a pigment is melted and mixed well so that the pigment is uniformly dispersed in the resin material. Then, the mixed material is then crushed with a pulverizer and then classified.

A color image forming apparatus uses three primary colored toners, i.e., yellow, magenta, and cyan or these three colored toners plus black toner. In order to achieve a desired color image, it is important that these three colors are balanced.

In order to add a high gloss to a color image, the toner needs to be transparent especially when an OHP sheet is used as a print medium. For this purpose, a silicone soft roller is used as a fixing roller to provide a large contact area between the toner and the paper so that the surface of a color image should be as smooth as possible.

A polymer having a narrow molecular weight is used as a resin material for toner. When such a toner is used, the toner layer that forms a toner image is not so resilient so that the toner is apt to adhere to the roller. Therefore, a large amount of silicone oil is supplied to the roller so that the roller attracts less toner.

However, with the aforementioned conventional image-forming apparatus, if a large amount of silicone oil is to be supplied to the roller, an oil-supplying device is necessary and therefore the overall size of the apparatus becomes large. The oil-supplying device is a consumable item. This leads to a higher cost of the image-forming apparatus.

Moreover, an image-forming apparatus where a large amount of silicone oil is supplied to the roller has a problem. That is, if a duplex printing is performed, one side of the print paper on which an amount of silicone oil has been deposited will move into contact with the fixing unit during a subsequent printing operation on the other side of the print paper. As a result, the silicone oil contaminates the fixing unit, causing poor fixing results. This leads to deterioration of print quality.

One way of preventing the toner from adhering to the roller without using silicone oil is to add a large amount of lubricant to the toner. However, the pressure and friction applied to the toner in the developing unit cause the problem that the lubricant spreads out from the toner. This deteriorates the image quality.

If silicone oil is not supplied to the fixing roller, the print paper after that has passed the fixing unit tends to be curled due to the difference in shrinkage between the toner and the print paper. On way of preventing the print paper from curling is to decrease an amount of toner that is deposited on the print paper. In that case, more coloring agent needs to be added to the toner. This increases the toner cost.

### SUMMARY OF THE INVENTION

An object of the invention is to provide a developer, a developer cartridge, and an image forming apparatus that solves the aforementioned problems.

Another object of the invention is to provide a developer, a developer cartridge, and an image forming apparatus that reduces the cost of the image-forming apparatus and increases the image quality. A developer contains a resin material, a colorant, and a lubricant. The ratio of a weight part of the lubricant to a weight part of the colorant is in the range of 0.3 to 10.0.

A developer contains a resin material, a colorant, and a lubricant. The colorant has a mean particle diameter in the range of 20 to 50 nm and a mean aggregate diameter in the range of 20 to 600 nm. The ratio of a weight part of the lubricant to a weight part of the colorant is in the range of 0.5 to 5.0.

A developer contains a resin material, a colorant, and a lubricant. The colorant has a mean particle diameter in the range of 40 to 80 nm and a mean aggregate diameter in the range of 40 to 800 nm. The ratio of a weight part of lubricant to a weight part of colorant is in the range of 1.0 to 10.0.

A developer contains a resin material, a colorant, and a lubricant. The colorant has a mean particle diameter in the range of 80 to 180 nm and a mean aggregate diameter in the range of 80 to 1000 nm. The ratio of a weight part of lubricant to a weight part of colorant is in the range of 0.3 to 4.0.

A developer contains a resin material, a colorant, and a lubricant. The colorant is obtained by blending two types of pigments that are different in mean particle diameter and mean aggregate diameter.

A developer cartridge holds the aforementioned developer.

An image forming apparatus incorporating a developer cartridge that holds the aforementioned developer. The image forming apparatus includes:

an image bearing body;

a charging unit that charges said image bearing body,

an exposing unit that forms an electrostatic latent image on said image bearing body charged by said charging unit;

a developing unit that develops the electrostatic latent image with a developer held in the developer cartridge into a visual image;

a transferring unit that transfers the visual image onto a print medium; and

a fixing unit that fixes the visual image on the print medium.

An image forming apparatus having:

an image bearing body;

a charging unit that charges said image bearing body;

an exposing unit that forms an electrostatic latent image on said image bearing body charged by said charging unit;

a developing unit that develops the electrostatic latent image with a developer into a visual image;

a transferring unit that transfers the visual image onto a print medium; and

a cleaning member in contact with the image bearing body to remove the developer remaining on the image bearing body after the visual image has been transferred onto the print medium;

wherein the cleaning member is pressed against the image bearing body under a line pressure in the range of 0.3 to 3.0 gf/mm.

The image forming apparatus incorporates the aforementioned developer cartridge.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illuminates a general construction of an electrophotographic image-forming apparatus according to the present invention;

FIG. 2 is a cross-sectional view of a toner cartridge according to a first embodiment; and

FIG. 3 illustrates the relationship between the amount of coloring agent and the image density p according to the present invention.

### DETAILED DESCRIPTION OF THE INVENTION

Embodiments of the invention will be described in detail with reference to the accompanying drawings.

First Embodiment

Image-Forming Apparatus

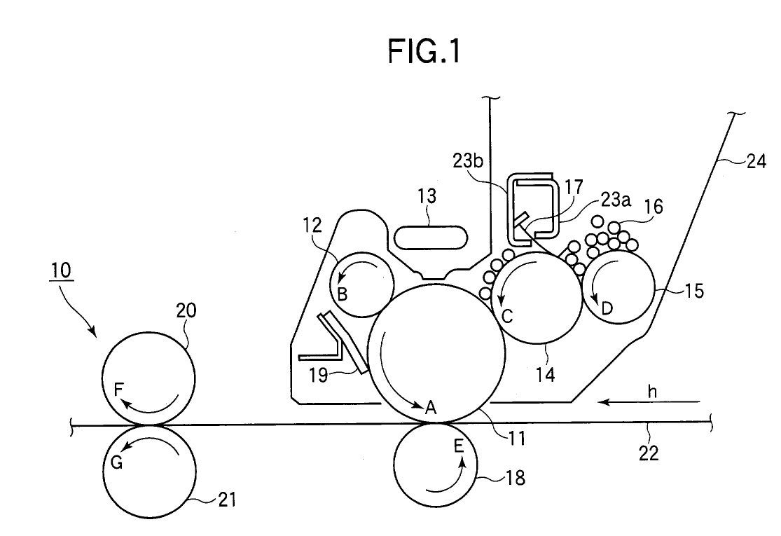

FIG. 1 illuminates a general construction of an electrophotographic image-forming apparatus according to the present invention.

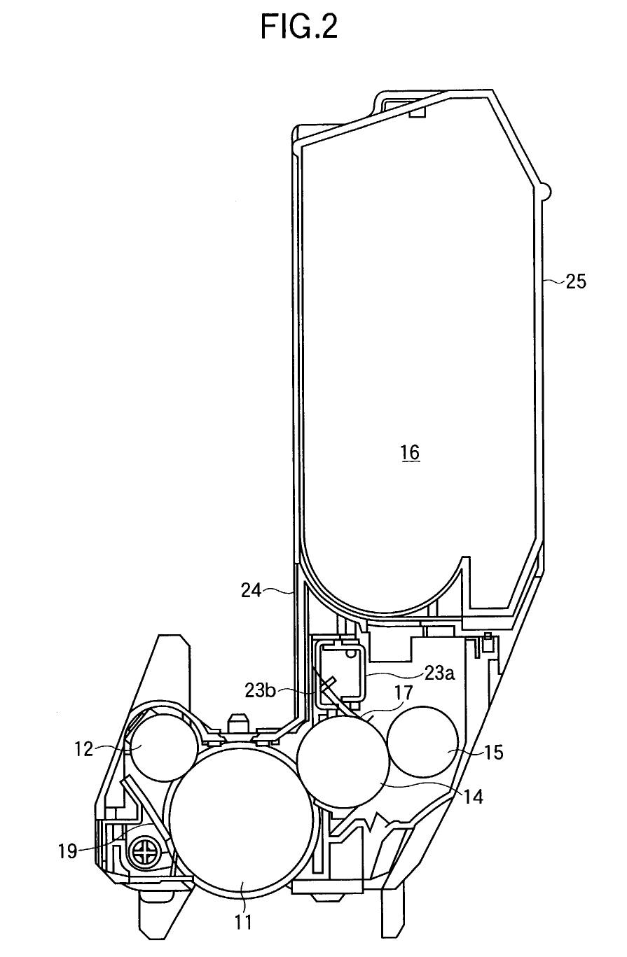

FIG. 2 is a cross-sectional view of a toner cartridge according to a first embodiment.

Referring to FIG. 1, a photoconductive drum 11 as an image bearing body rotates in a direction shown by arrow A. A charging roller 12 rotates in contact with the photoconductive drum 11 in a direction shown by arrow B. The charging roller 12 receives a high voltage from a supply, not shown, and charges the surface of the photoconductive drum 11. The charging roller 12 may be replaced by a non-contact type charging unit such as a scorotron or a corotron.

The photoconductive drum 11 includes an electrically conductive supporting member such as aluminum pipe having an outer diameter of 30 mm. A charge generating layer having a thickness of about 0.5 μm that serves as an photoconductive layer is formed on the aluminum pipe. A charge transfer layer having a thickness of about 18 μm on the charge generating layer, thereby forming an organic photoconductive body.

A stainless pipe or a steel pope may be used in place of the aluminum pipe. A laminated structure of the charge generating layer and the charge transferring layer may be replaced by a single layer that serves as both a charge generating layer and a charge transferring layer.

An LED head 13 serves as an exposing unit that illuminates the surface of the photoconductive drum 11 charged by the charging roller 12 to form an electrostatic latent image. The LED head 13 includes an LED array and a rod lens, not shown. A laser apparatus, which is a combination of a laser source and an optical imaging system, may be used in place of the LED head 13. A developing roller 14 rotates in contact with or in non-contact with the photoconductive drum 11 in a direction shown by arrow C. The developing roller 14 delivers toner 16 as a developer to the developing areas, so that the toner 16 is deposited onto an electrostatic latent image by a developing bias voltage to develop the electrostatic latent image into a toner image. A toner-supplying roller 15 rotates in contact/non-contact with the developing roller 14 in a direction shown by arrow D and supplies the toner 16 to the developing roller 14. A developing blade 17 makes a thin layer of the toner 16 on the developing roller 14, the toner 16 being delivered by the toner-supplying roller 15 to the developing roller 14. The developing roller 14, toner-supplying roller 15, and developing blade 17 form a developing unit.

The developing roller 14 has a resilient sleeve formed of, for example, silicone rubber or urethane rubber, a metal sleeve formed of a metal materials such as aluminum or SUS, or a drawn ceramic material.

In order to smoothly deliver and charge the toner 16, the surface of the developing roller 14 is subjected to a treatment such as oxidizing, polishing, or blasting or is coated with a resin material.

The toner layer is formed on the developing roller 14 by causing the developing blade 17 to abut the surface of the developing roller 14. The developing blade 17 is preferably made of a resilient material such as silicone rubber, urethane rubber or SUS. The developing blade 17 may also be made of a resilient material that contains an organic material or an inorganic material that is added and dispersed in the resilient material to adjust the charging of the toner 16.

A transfer roller 18 rotates in contact with the photoconductive drum 11 in a direction shown by arrow E. The transfer roller 18 receives a voltage from a power supply, not shown, and transfers a toner image formed on the photoconductive drum 11 onto the print paper 22 such as ordinary paper and transparency that is advanced in a direction shown by arrow H. A non-contact corotron type transfer unit may be used in place of the transfer roller 18. A cleaning blade 19 removes the toner 16 that remains on the photoconductive drum 11 after the toner image is transferred onto the print paper 22. A cleaning unit according to the present embodiment is of the blade cleaning type in which a rubber blade is in contact with the photoconductive drum 11. The cleaning blade 19 may be replaced by a cleaning roller or a cleaning brush.

A fixing unit 10 fuses the toner image on the print paper 22. The fixing unit 10 includes a heat roller 20 and a pressure roller 21. The heat roller 20 rotates in a direction shown by arrow F and receives electric power from a supply, not shown, to generate heat. The pressure roller 21 rotates in a direction shown by arrow G and presses the print paper against the heat roller 20. Thus, the toner 16 of the toner image is melted by heat under pressure. The heat roller 20 and pressure roller 21 form a fixing roller unit. In the present embodiment, the fixing unit 10 is of the roller type but may be of the belt type that uses a belt, film type that uses a film, or flash type that uses photo-energy. A roller type fixing unit or a belt type fixing unit is an oil-free fixing system in which an oil such as silicone oil is not supplied, thereby preventing “hot off-set” from occurring. Thus, a roller type fixing unit or a belt type fixing unit eliminates an oil-supplying unit that is a consumable item, allows miniaturizing of an image-forming apparatus, and reduces the cost of the image-forming apparatus.

Reference numerals 21a and 21b denote blade stoppers. Reference numerals 24 and 25 denote an ID unit and a toner cartridge that accommodates the toner 16, respectively.

The charging roller 12 charges the surface of the photoconductive drum 11 uniformly. The LED head 13 illuminates the charged surface of the photoconductive drum 11 to form an electrostatic latent image on the photoconductive drum 11. The developing unit develops the electrostatic latent image with toner into a toner image. The toner image is then transferred onto the print paper 22 by the transfer roller 18. The fixing unit 10 fuses the toner image on the print paper 22 into a permanent image. The present embodiment uses a non-magnetic single component toner as the toner 16.

Toner and Toner Cartridge

Embodiments of the toner cartridge 25 and the toner 16 will now be described.

A blend of the following materials was prepared: 100 weight parts of polyester resin (number average molecular weight Mn=3700, glass transition temperature Tg=62° C.), 1.0 weight parts of salicylic acid complex as a charging controlling agent, predetermined weight parts of carbon black “MOGUL-L” (available from CABOT, mean particle diameter: 25 nm), and predetermined weight parts of wax such as carnauba wax (melting point=80° C.) that serves as a lubricant. Carnauba wax has a lower molecular amount than the binding resin. This blend was sufficiently agitated with a Henschel mixer and then kneaded. After kneading, the material was heated at 120° C. for 3 hours in a roller mill and was then cooled to room temperature. The thus obtained material was crushed with DISPERSION SEPARATOR (Japan Pneumatic Industry Company Ltd.) as a pulverizer, then classified to obtain particles having a mean particle diameter of 8 μm.

Then, 2.0 weight parts of silica R972 (Aerosil Japan) as a fluidity adding agent was added to the surfaces of the particles, thereby obtaining a final product of toner.

The following materials were added to a blend of 80 weight parts of styrene and 20 weight parts of acrylic acid-n-butyl: 1.0 weight parts of salicylic acid complex as a charging controlling agent; 1.0 weight parts of t-dodecyl mercapta; 1.0 weight parts of 2,2′-azobisisobutyronitrile, predetermined weight parts of polyethylene wax (melting point=80° C.) that serves as a lubricant, and predetermined weight parts of carbon black “MOGUL-L” (available from CABOT, mean particle diameter is 25 nm) as a coloring agent.

Then, the material was introduced into a pulverizer (“MA-01SC” available from Mitsui-Miike Kakoki) and dispersed at 15° C. for 10 hours to obtain a polymerized composition.

Further, 180 weight parts of ethanol melted in 8.0 weight parts of polyacrylic and 0.35 weight part of divinylbenzene were prepared and then added to 600 weight parts of distilled water, thereby preparing a dispersion medium for polymerization.

The polymerization composition was added to this dispersion medium and dispersed in a TK homo-mixer (“M type” available from TOKUSHU KIKA KOGYO CO., LTD. at 15° C. for 10 minutes under 8000 revolutions. Then, the thus obtained dispersion medium was put into a separable flask of a 1-liter capacity and subjected to reaction at 85° C. for 12 hours while agitating at 100 r.p.m. in the flow of nitrogen gas.

The dispersoid obtained through polymerization reaction of the polymerization composition at this stage is referred to as intermediate particles. Then, using Model US-150 ultrasonic transmitter (Nippon Seiki), an emulsion was adjusted in the aqueous suspension of the intermediate particles. The emulsion is formed of 9.25 weight parts of methyl methacrylate, 0.75 weight parts of acrylic acid-n-butyl, and 0.5 weight parts of 2,2′-azobisisobutyronitrile, 0.1 weight parts of sodium lauryl sulphate, and 80 weight parts of water.

The emulsion by 9 weight parts was dropped on the intermediate particles so that the intermediate particles swelled.

Immediately after dropping the emulsion, the intermediate particles were observed under an optical microscope. No drip of emulsion was observed. This indicates that swelling had completed in a short time. The material was then subjected to the second stage of polymerization at 85° C. for 10 hours while agitating in a nitrogen atmosphere. After cooling the material, the dispersion medium was melted in a 0.5N aqueous solution of hydrochloric acid, and then filtered. Thereafter, the material was washed in water and dried in wind. Then, the material was further dried in an atmosphere of 10 mm Hg at 40° C. for 10 hours. Then, the material was classified with a pneumatic separator, thereby providing particles having an average diameter of 7 μm. Two weight parts of silica R972 (Aerosil Japan) as a fluidity adding agent was added to the surfaces of the particles to produce a final product of toner B.

Toner A and toner B were observed under a transmission electron microscope (TEM). The observation revealed that the encapsulated coloring agent having a mean aggregate diameter in the range of 25 to 400 nm. After dispersion, the particles of coloring agent may not necessarily be in the form of single particles but in the form of clumps of several particles. The average diameter of a clump of a plurality of particles is referred to as dispersion diameter.

This toner was used as the toner 16 for the image-forming apparatus in FIG. 1. The image-forming apparatus was modified such that the high voltage supplied to the developing unit and the fixing temperature of the fixing unit 10 can be controllably changed.

The voltage applied to the developing unit was adjusted such that the amount of toner deposited on the print paper 22 is 0.6 mg/cm². Ordinary white paper (Xerox J paper, available from Xerox) was used as the print paper 22. The image density ρ of the respective colored toner was measured with XRite 528 (STATUS I) to find the relationship between the amount of coloring agent and image density ρ for different particle diameters.

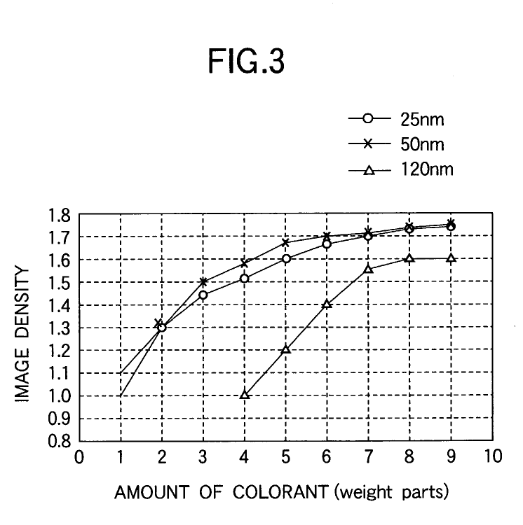

FIG. 3 illustrates the relationship between the amount of coloring agent and the image density ρ according to the present invention. Referring to FIG. 3, the symbol ◯ denotes the relation for a diameter of 25 nm (mean aggregate diameter: 25-400 nm), the symbol Δ denotes the relation for a diameter of 50 nm (mean aggregate diameter: 50-600 nm), and the symbol denotes the relation for a diameter of 120 nm (mean aggregate diameter: 120-1000 nm). Here, the respective particle diameters are mean particle diameters.

As shown in FIG. 3, 2-7 weight parts of the coloring agent provides good image density ρ in the range of 1.3≦ρ≦1.7, which can be accepted as normal image quality.

When the value of ρ is lower than 1.3, it is determined that the print result is not sufficiently dense and the print is blurred. When the value of ρ is higher than 1.7, it is determined that the print result is too dense and an image of half-tone has lost its details.

Two types of toners were manufactured according to the aforementioned method: toner A and toner B. In other words, the toners were made by adding 4.0 weight parts of carbon black having a mean particle diameter in the range of 20 to 50 nm, and by adding different amounts of lubricant, i.e., 1 weight parts, 5 weight parts, 10 weight parts, and 15 weight parts. The toners were observed under a TEM (transmission electron microscope). The mean aggregate diameter of carbon black was in the range of 20 to 600 nm. The respective toners were evaluated as in the following manner. A continuous printing operation of 50,000 pages was performed at a print duty of 5% and the print results were observed in terms of image quality and the filming of toner on the photoconductive drum 11. The print paper 22 of a size A4 (FIG. 1) was transported in its lateral direction. Filming is a phenomenon in which toner and toner compositions melt to make a thin film on the surface of a photoconductive drum.

Table 1 lists the test results when carbon black having a mean particle diameter of 25 nm (mean aggregate diameter: 25-400 nm) was used. Similar results were obtained for carbon black having a mean particle diameter of 30 nm (mean aggregate diameter 35-600 nm) and carbon black having a mean particle diameter of 30 nm (mean aggregate diameter 35-600 nm). Similar results were also obtained for toner A when another type of carnauba wax having a melting point in the range of 75 to 80° C. was used, and for toner B when another type of polyethylene wax having a melting point in the range of 55 to 75° C. was used.

TABLE 1

| amount of | filming of toner | filming of toner |
|---|---|---|
| lubricant | A | B |
| 1 | excellent | excellent |
| 5 | excellent | good |
| 10 | good | good |
| 15 | poor | poor |

(Mean particle diameter is 25 nm (mean aggregate diameter is in the range of 25 to 400 nm).

For toner A that contains 1 weight parts of lubricant, toner A that contains 5 weight parts of lubricant, and toner B that contains 1 weight parts of lubricant, the image quality was good after printing 50,000 pages. No deposition of foreign material was observed on the photoconductive drum. No filming occurred.

For toner A that contains 10 weight parts of lubricant, toner B that contains 5 weight parts of lubricant, and toner B that contains 10 weight parts of lubricant, the image quality was good after printing about 40,000 pages. Only a small amount of deposition of foreign material on the photoconductive drum was observed. The substantially the same image quality was observed after printing about 50,000 pages though only a small amount of deposition of foreign material was observed on the photoconductive drum.

For toner A and toner B that contain 15 weight parts of lubricant, only a small amount of foreign material was observed after continuous printing of about 50,000 pages. Marks of foreign materials were observed on the color print after continuous printing of additional about 5000 pages. Large foreign materials were observed on the photoconductive drum 11 by visual inspection. The foreign materials were observed under a TEM (transmission electron microscope) and found on the photoconductive drum 11. A large amount of foreign materials was also observed on the photoconductive drum 11 when an infrared absorption spectrometry was performed.

The results of TEM observation and infrared absorption spectrometry reveal that adding 15 weight parts or more of the lubricant will cause the toner to be deposited on the photoconductive drum 11 to result in filming.

Toners listed in Table 2 were manufactured by selecting the amounts of the coloring agent (weigh part), which represents the amount of carbon black of the aforementioned toners, and the lubricant (weight parts). For the respective toners, a continuous printing operation of 30 pages was performed at a print duty of 100%. The print paper 22 of a size A4 was transported in its lateral direction. Table 2 lists the results of visual inspection of the image quality.

TABLE 2

| | amount of | | | toner A | toner B |
|---|---|---|---|---|---|
| | coloring | amount of | ratio | fixing | fixing |
| Example | agent | lubricant | γ | margin | margin |
| 1-1 | 2 | 10 | 5.00 | 10-30° C. | 10-30° C. |
| 1-2 | 3 | 10 | 3.33 | 10-30° C. | >30° C. |
| 1-3 | 4 | 10 | 2.50 | >30° C. | >30° C. |
| 1-4 | 5 | 10 | 2.00 | >30° C. | >30° C. |
| 1-5 | 6 | 10 | 1.67 | >30° C. | >30° C. |
| 1-6 | 7 | 10 | 1.43 | >30° C. | >30° C. |
| 1-7 | 2 | 1 | 0.50 | 10-30° C. | >30° C. |
| 1-8 | 3 | 1 | 0.33 | <10° C. | <10° C. |
| 1-9 | 4 | 1 | 0.25 | <10° C. | <10° C. |
| 1-10 | 5 | 1 | 0.20 | <10° C. | <10° C. |
| 1-11 | 6 | 1 | 0.17 | <10° C. | <10° C. |
| 1-12 | 7 | 1 | 0.14 | <10° C. | <10° C. |

(Ratio γ represents the weight ratio of the coloring agent to the lubricant.)

Fixing margin is the difference between a temperature below which fixing result is poor (referred to as cold offset) and a temperature above which fixing result is poor (referred to as hot offset), i.e., a tolerable range in which the fixing temperature is allowed to fluctuate. A large fixing margin is usually desirable. If the fluctuation of fixing temperature is within a margin, normal print quality can be obtained. When the print paper enters the fixing unit in the standby state, the fixing temperature fluctuates by a maximum amount. When the fixing unit is in a high temperature and high humidity environment, if the fixing margin is larger than 30° C., no poor fixing results occurs. When the fixing unit is in a room temperature environment, poor fixing results do not occur if the fixing margin is in the range of 10 to 30° C.

From the results in Table 2, a ratio γ≧3.3 causes a small amount of toner to be deposited on the heat roller 20 and the pressure roller 21. Poor fixing resulted but the image quality was good. A ratio γ in the range of 0.5≦γ≦2.5 causes only a small amount of toner to be deposited on the heat roller 20 and the pressure roller 21. No poor fixing resulted and the image quality was good.

In order to prevent poor fixing and maintain good image quality, the amount of lubricant added to the toner is preferably in the range of 1 to 10 weight parts and 0.5≦γ≦5 and more preferably 0.5≦γ≦2.5.

Second Embodiment

The following materials were added to a blend of 100 weight parts of polyester resin (number average molecular weight Mn=3700, glass transition temperature Tg=62° C.) and 1.0 weight parts of salicylic acid complex: predetermined weight parts of C.I. Pigment Blue 15:3 (mean particle diameter: 50 nm) as a cyan coloring agent and predetermined weight parts of a wax as a lubricant, for example, carnauba wax (meting point: 80° C.).

This blend was well agitated with a Henschel mixer and kneaded. After kneading, the material was heated at 120° C. for 3 hours in a roller mill and was then cooled to room temperature. The thus obtained material was crushed with the DISPERSION SEPARATOR, and then classified to obtain particles having a mean particle diameter of 8 μm.

Then, silica R972 by 2.0 weight parts was added to the surfaces of the particles, thereby obtaining a final product of toner.

The following materials were added to a blend of 80 weight parts of styrene and 20 weight parts of acrylic acid-n-butyl: 1.0 weight parts of salicylic acid complex as a charging controlling agent, 1.0 weight parts of t-dodecyl mercaptan, 1.0 weight parts of 2,2′-azobisisobutyronitrile, predetermined weight parts of polyethylene wax (melting point=60° C.) that serves as a lubricant, and a predetermined weight art of C.I. Pigment Blue 15:3 (mean particle diameter is 50 nm) as a coloring agent.

Then, the material was introduced into a pulverizer (“MA-01SC” available form Mitsui Miike Kakoki) and dispersed at 15° C. for 10 hours to obtain a polymerized composition.

Further, 180 weight parts of ethanol melted in 8.0 weight parts of polyacrylic and 0.35 weight part of divinylbenzene was prepared and then added to 600 weight parts of distilled water, thereby preparing a dispersion medium for polymerization.

The polymerized composition was added to this dispersion medium and dispersed in a TK homo-mixer (“M type” available from TOKUSHU KIKA KOGYO CO., LTD) at 15° C. for 10 minutes under 8000 revolutions. Then, the thus obtained dispersion medium was put into a separable flask of a 1-liter capacity and subjected to reaction at 85° C. for 12 hours while agitating at 100 r.p.m. in the flow of nitrogen gas.

The dispersoid at this stage obtained through the polymerization reaction of polymerized composition_is referred to as intermediate particles. Then, using Model US-150 ultrasonic transmitter transmitter (Nippon Seiki), an emulsion was adjusted in the aqueous suspension of the intermediate particles. This emulsion is formed of 9.25 weight parts of methyl methacrylate, 0.75 weight parts of acrylic acid-n-butyl, 0.5 weight parts of 2,2′-azobisisobutyronitrile, 0.1 weight parts of sodium lauryl sulphate, and 80 weight parts of water.

The emulsion by 9 weight parts was dropped on the intermediate particles, so that the intermediate particles swelled.

Immediately after dropping the emulsion, the intermediate particles were observed under an optical microscope. No drip of emulsion was observed. This indicates that the swelling of the intermediate particles had completed in a short time. The material was then subjected to the second stage of polymerization at 85° C. for 10 hours while agitating in a nitrogen atmosphere. After cooling the material, the dispersion medium was melted in a 0.5N aqueous solution of hydrochloric acid, and then filtered. Thereafter, the material was washed in water and dried in wind. Then, the material was further dried for 10 hours in an atmosphere of 10 mm Hg at 40° C. Then, the material was classified with a pneumatic separator, thereby providing particles having an average diameter of 7 μm. Two weight parts f silica R972 (Aerosil Japan) as a fluidity adding agent was added to the surfaces of the particles to produce a final product of toner D. The thus classified toner was observed under a TEM (transmission electron microscope). The mean aggregate diameter of particles of an encapsulated coloring agent was in the range of 50 to 600 nm.

This toner was used as the toner 16 for the image-forming apparatus in FIG. 1. The image-forming apparatus was modified such that the high voltage supplied to the developing unit and the fixing temperature of the fixing unit 10 can be controllably changed.

The voltage applied to the developing unit was adjusted such that the toner deposited on the print paper 22 is 0.6 mg/cm². Ordinary white paper (available from Xerox) was used as the print paper 22. The image density ρ of the respective colored toner was measured with XRite 528 to find the relationship between the amount of coloring agent and the image density ρ for different particle diameters.

As shown in FIG. 3, 2-7 weight parts of the coloring agent provides good image density p in the range of 1.3≦ρ≦1.7, which can be accepted as normal image quality.

When the value of ρ is lower than 1.3, it is determined that the print result is not sufficiently dense and the print is blurred. When the value of ρ is higher than 1.7, it is determined that a print result is too dense and an image of half-tone has lost its details.

Toners were manufactured according to the aforementioned method. In other words, the toner was made by adding 4.0 weight parts of C.I. Pigment Blue 15:3 having a mean particle diameter in the range of 40 to 80 nm and by adding different amounts of lubricant, i.e., 2 weight parts, 10 weight parts, 20 weight parts, and 25 weight parts. The toners were observed under the TEM. The mean aggregate diameter of C.I. Pigment Blue 15:3 was in the range of 40 to 800 nm. The toner was evaluated as in the following manner. A continuous printing operation of 50,000 pages was performed at a print duty of 5% and the print results were observed in terms of image quality and the filming of toner on the photoconductive drum 11. The print paper 22 of a size A4 (FIG. 1) was transported in a lateral direction.

Table 1 lists the test results when C.I. Pigment Blue 15:3 having a mean particle diameter of 50 nm (mean aggregate diameter: 50-600 nm). Similar results were obtained for C.I. Pigment Blue 15:3 having a mean particle diameter of 60 nm (mean aggregate diameter: 60-700 nm) and C.I. Pigment Blue 15:3 having a mean particle diameter of 70 nm (mean aggregate diameter: 70-800 nm). Similar results were also obtained for C.I. Pigment yellow 17 and C.I. Pigment R57:1. Further, similar results were obtained for toner C with another type of carnauba wax having a melting point in the range of 75 to 85° C. and for toner D with another type of polyethylene wax having a melting point in the range of 55 to 75° C.

TABLE 3

| amount of | filming of toner | filming of toner |
|---|---|---|
| lubricant | C | D |
| 2 | excellent | excellent |
| 10 | excellent | good |
| 20 | good | good |
| 20 | poor | poor |

(Mean particle diameter is 50 nm (mean aggregate diameter is in the range of 50 to 600 nm).

For toner C that contains 10 weight parts or less of lubricant and toner D that contains 2 weight parts or less of lubricant, the image quality was good after printing 50,000 pages. No deposition of foreign material was observed on the photoconductive drum. No filming occurred.

For toner C that contains 20 weight parts of lubricant, toner D that contains 10 weight parts of lubricant, and toner D that contains 20 weight parts of lubricant, only a small amount of foreign material was observed after printing about 40,000 pages. The image quality was good. After printing 50,000 pages, little or no change in image quality was observed. Although only a small amount of foreign material was deposited on the surface o the photoconductive drum 11, the image quality was good.

For toner C and toner D that contain 25 weight parts of lubricant, only a small amount of foreign material was observed after continuous printing of about 5000 pages. Marks of foreign materials were observed on the printed color image after continuous printing of additional about 5000 pages. Large foreign materials were observed on the photoconductive drum 11 by visual inspection. The foreign materials were examined under a TEM (transmission electron microscope) and found on the photoconductive drum 11. A large amount of foreign materials was also observed on the photoconductive drum 11 when infrared absorption spectrometry was performed.

The results of TEM observation and infrared absorption spectrometry reveal that adding 25 weight parts or more of lubricant will cause the toner to be deposited on the photoconductive drum to result in filming.

Toners listed in Table 4 were manufactured by selecting the amounts of the coloring agent (in weigh parts) and the lubricant (in weight parts), the coloring agent representing the amount of C.I. Pigment Blue 15:3 of the aforementioned toners. For the respective toners, a continuous printing operation of 30 pages was performed at a print duty of 100%. The print paper 22 of a size A4 (FIG. 1) was transported in its lateral direction. Table 4 lists the results of visual inspection of the image quality.

TABLE 4

| | amount of | | | toner A | toner B |
|---|---|---|---|---|---|
| | coloring | amount of | ratio | fixing | fixing |
| Example | agent | lubricant | γ | margin | margin |
| 2-1 | 2 | 20 | 10.00 | 10-30° C. | 10-30° C. |
| 2-2 | 3 | 20 | 6.67 | 10-30° C. | >30° C. |
| 2-3 | 4 | 20 | 5.00 | >30° C. | >30° C. |
| 2-4 | 5 | 20 | 4.00 | >30° C. | >30° C. |
| 2-5 | 6 | 20 | 3.33 | >30° C. | >30° C. |
| 2-6 | 7 | 20 | 2.86 | >30° C. | >30° C. |
| 2-7 | 2 | 2 | 1.00 | 10-30° C. | >30° C. |
| 2-8 | 3 | 2 | 0.67 | <10° C. | <10° C. |
| 2-9 | 4 | 2 | 0.50 | <10° C. | <10° C. |
| 2-10 | 5 | 2 | 0.40 | <10° C. | <10° C. |
| 2-11 | 6 | 2 | 0.33 | <10° C. | <10° C. |
| 2-12 | 7 | 2 | 0.29 | <10° C. | <10° C. |

(Ratio γ represents the weight ratio of the coloring agent to the lubricant.)

Fixing margin is the difference between a temperature below which fixing result is poor (referred to as cold offset) and a temperature above which fixing result is poor (referred to as hot offset), i.e., a tolerable range in which the fixing temperature fluctuates. A large fixing margin is usually desirable. If the fluctuation of fixing temperature is within a margin, normal print quality can be obtained. When the print paper enters the fixing unit in the standby state, the fixing temperature fluctuates by a large amount. When the fixing unit is in a high temperature and high humidity environment, if the fixing margin is larger than 30° C., no poor fixing result occurs. When the fixing unit is in a room temperature environment, poor fixing result does not occur if the fixing margin is in the range of 10 to 30° C.

From the results in Table 2, a ratio γ≧6.67 causes a small amount of toner to be deposited on the heat roller 20 and the pressure roller 21. Poor fixing resulted but the image quality was good. A ratio γ in the range of 1.00≦γ≦5.00 does not cause toner to be deposited on the heat roller 20 and the pressure roller 21. No poor fixing resulted and the image quality was good.

In order to prevent poor fixing and maintain good image quality, the amount of lubricant added to the toner is preferably in the range of 2 to 20 weight parts and the ratio γ is preferably in the range of 1.00≦γ≦10.00 and more preferably 1.00>γ≦5.00.

Third Embodiment

Predetermined weight parts of C.I. Pigment Red 122 (mean particle diameter: 120 nm) as a magenta coloring agent and predetermined weight parts of, for example, carnauba wax (meting point: 80° C.) as a lubricant were added to a blend of 100 weight parts of polyester resin (number average molecular weight Mn: 3700, glass transition temperature Tg: 62° C.) and 1.0 weight parts of salicylic acid complex. This blend was well agitated with a Henschel mixer and kneaded. After kneading, the material was heated at 120° C. for 3 hours in a roller mill and was then cooled to room temperature. The thus obtained material was crushed with the DISPERSION SEPARATOR, and then classified to obtain particles having a mean particle diameter of 8 μm. Two weight parts of silica R972 was added as a fluidity adding agent to the surfaces of the particles to produce a final product of toner E.

The following materials were added to a blend of 80 weight parts of styrene and 20 weight parts of acrylic acid-n-butyl: 1.0 weight parts of salicylic acid complex as a charging controlling agent, 1.0 weight parts of t-dodecyl mercaptan, 1.0 weight parts of 2,2′-azobisisobutyronitrile, predetermined weight parts of polyethylene wax such as carnauba wax (melting point=80° C.) that serves as a lubricant, and a predetermined weight part of C.I. Pigment Red 122 (mean particle diameter: 50 nm) as a coloring agent.

Then, the material was introduced into a pulverizer (“MA-01SC” available form Mitsui Miike Kakoki) and dispersed at 15° C. for 10 hours to obtain a polymerized composition.

Further, 180 weight parts of ethanol melted in 8.0 weight parts of polyacrylic and 0.35 weight part of divinylbenzene was prepared and then added to 600 weight parts of distilled water, thereby preparing a dispersion medium for polymerization.

The polymerization composition was added to this dispersion medium and dispersed in a TK homo-mixer (“M type” available from TOKUSHU KIKA KOGYO CO., LTD) at 15° C. for 10 minutes under 8000 revolutions. Then, the thus obtained dispersion medium was put into a separable flask of a 1-liter capacity and subjected to reaction at 85° C. for 12 hours while agitating at 100 r.p.m. in the flow of nitrogen gas.

The dispersoid obtained through the polymerization reaction of polymerization composition at this stage is referred to as intermediate particles. Then, using Model US-150 ultrasonic transmitter (Nippon Seiki), an emulsion was adjusted in the aqueous suspension of the intermediate particles. The emulsion is formed of 9.25 weight parts of aqueous suspension of methyl methacrylate, 0.75 weight parts of acrylic acid-n-butyl, and 0.5 weight parts of 2,2′-azobisisobutyronitrile, 0.1 weight parts of sodium lauryl sulphate, and 80 weight parts of water.

The emulsion by 9 weight parts was dropped on the intermediate particles, so that the intermediate particles swelled.

Immediately after dropping the emulsion, the intermediate particles were observed under an optical microscope. No emulsion was observed. This indicates that swelling had completed in a short time. The material was then subjected to the second stage of polymerization for 10 hours, while being agitated in a nitrogen atmosphere. After cooling the material, the dispersion medium was melted in a 0.5N aqueous solution of hydrochloric acid, and then filtered. Thereafter, the material was washed in water and dried in wind. Then, the material was further dried in an atmosphere of 10 mm Hg at 40° C. for 10 hours. Then, the material was classified with a pneumatic separator, thereby providing particles having an average diameter of 7 μm. Two weight parts of silica R972 as a fluidity adding agent was added to the surfaces of the particles to produce a final product of toner F. The thus classified toner was observed under a TEM (transmission electron microscope). The mean aggregate diameter of encapsulated fine particles of the coloring agent was in the range of 120 to 850 nm.

This toner was used as the toner 16 for the image forming apparatus in FIG. 1. The image forming apparatus was modified such that the high voltage supplied to the developing unit and the fixing temperature of the fixing unit 10 can be controllably changed.

The voltage applied to the developing unit was adjusted such that the toner deposited on the print paper 22 is 0.6 mg/cm². Ordinary white paper (Xerox J paper, available from Xerox) was used as the print paper 22. The image density ρ of the respective colored toner was measured with XRite 528 to find the relationship between the amount of coloring agent and image density ρ for different particle diameters.

As shown in FIG. 3, 2-7 weight parts of the coloring agent provides good image density ρ in the range of 1.3≦ρ≦1.7, which can be accepted as normal image quality.

When the value of ρ is lower than 1.3, it is determined that the print result is not sufficiently dense and the print is blurred. When the value of ρ is higher than 1.7, it is determined that a print result is too dense and an image of half-tone has lost its details.

Toners were manufactured according to the aforementioned method. In other words, the toners were made by adding 6.0 weight parts of C.I. Pigment Red 122 having a mean particle diameter in the range of 80 to 180 nm, by adding different amounts of lubricant, i.e., 2 weight parts, 10 weight parts, 20 weight parts, and 25 weight parts. The mean aggregate diameter of C.I. Pigment Red 122 was in the range of 80 to 1000 nm. The respective toners were evaluated as in the following manner. The print paper 22 of a size A4 (FIG. 1) was transported in its lateral direction. A continuous printing operation of 50,000 pages was performed at a print duty of 5% and the print results were observed in terms of image quality and the filming of toner on the photoconductive drum 11.

Table 5 lists the test results when C.I. Pigment Red 122 having a mean particle diameter of 120 nm (mean aggregate diameter: 120-850 nm). Similar results were obtained for different C.I. Pigment Red 122 having mean particle diameters of 100 nm (mean aggregate diameter: 100-800 nm), 140 nm (mean aggregate diameter: 140-900 nm), and 160 nm (mean aggregate diameter: 160-1000 nm). Similar results were also obtained for toner E when another carnauba wax having a melting point in the range of 75 to 80° C. was used, and for toner F when another polyethylene wax having a melting point in the range of 55 to 75° C. was used.

TABLE 5

| amount of | filming of toner | filming of toner |
|---|---|---|
| lubricant | E | F |
| 2 | excellent | excellent |
| 10 | excellent | good |
| 20 | good | good |
| 25 | poor | poor |

(Mean particle diameter is 120 nm (mean aggregate diameter is in the range of 120 to 850 nm).

For toner E that contains 10 weight parts or less of lubricant and toner F that contains 2 weight parts or less of lubricant, the image quality was good after printing 50,000 pages. No deposition of foreign material was observed on the photoconductive drum. No filming occurred.

For toner E that contains 20 weight parts or less of lubricant and toner F that contains 10 weight parts of lubricant, and toner F that contains 20 weight parts of lubricant, the image quality was good when continuous printing of about 40,000 pages was performed. Only a small amount of foreign material was observed on the photoconductive drum 11 but the image quality was good. After printing 50,000 pages substantially, the same image quality was obtained though only a small amount of foreign material was observed on the photoconductive drum 11.

For toner E and toner F that contain 25 weight parts of lubricant, only a small amount of foreign material was observed after continuous printing of about 5000 pages. Marks of foreign materials were observed on the color print after continuous printing of additional about 5000 pages. Large foreign materials were observed on the photoconductive drum 11 by visual inspection. The foreign materials were observed under a TEM (transmission electron microscope). The observation revealed that the foreign material have firmly been deposited on the photoconductive drum 11. A large amount of foreign materials was also observed on the photoconductive drum 11 when an infrared absorption spectrometry was performed.

The results of TEM observation and infrared absorption spectrometry reveal that adding 25 weight parts or more of the lubricant will cause the toner to be deposited on the photoconductive drum to result in filming.

Toners listed in Table 6 were manufactured by selecting the amounts of the coloring agent (in weigh part) and the lubricant (in weight parts), the coloring agent representing the amount of C.I. Pigment Red 122 of the aforementioned toners. For the respective toners, a continuous printing operation of 30 pages was performed at a print duty of 100%. The print paper 22 of a size A4 (FIG. 1) was transported in its lateral direction. Table 6 lists the results of visual inspection of the image quality.

TABLE 6

| | amount of | | | toner E, | toner F, |
|---|---|---|---|---|---|
| | coloring | amount of | ratio | fixing | fixing |
| Example | agent | lubricant | γ | margin | margin |
| 3-1 | 5 | 20 | 4.00 | 10-30° C. | 10-30° C. |
| 3-2 | 5.5 | 20 | 3.64 | 10-30° C. | 10-30° C. |
| 3-3 | 6 | 20 | 3.33 | 10-30° C. | 10-30° C. |
| 3-4 | 6.5 | 20 | 3.08 | 10-30° C. | 10-30° C. |
| 3-5 | 7 | 20 | 2.86 | 10-30° C. | 10-30° C. |
| 3-6 | 7.5 | 20 | 2.67 | 10-30° C. | 10-30° C. |
| 3-7 | 8 | 20 | 2.50 | 10-30° C. | >30° C. |
| 3-8 | 5 | 10 | 2.00 | >30° C. | >30° C. |
| 3-9 | 8 | 10 | 1.25 | >30° C. | >30° C. |
| 3-10 | 5 | 2 | 0.40 | >30° C. | >30° C. |
| 3-11 | 5.5 | 2 | 0.36 | >30° C. | >30° C. |
| 3-12 | 6 | 2 | 0.33 | >30° C. | >30° C. |
| 3-13 | 6.5 | 2 | 0.31 | >30° C. | >30° C. |
| 3-14 | 7 | 2 | 0.29 | 10-30° C. | >30° C. |
| 3-15 | 7.5 | 2 | 0.27 | <10° C. | <10° C. |
| 3-16 | 8 | 2 | 0.25 | <10° C. | <10° C. |

From the results in Table 6, a value of ratio, γ≧2.5 causes a small amount of toner to be deposited on the heat roller 20 and the pressure roller 21. No poor fixing resulted but the image quality was good. A ratio γ in the range of 0.29≦γ≦2.00 causes toner to be deposited on the heat roller 20 and the pressure roller 21. No poor fixing resulted and the image quality was good.

In order to prevent poor fixing and maintain good image quality, the amount of lubricant added to the toner is preferably in the range of 2 to 20 weight parts and the ratio is preferably in the range of 0.3≦γ≦4.00 and more preferably 0.3≦γ≦2.00.

Fourth Embodiment

The following materials were added to a blend of 100 weight parts of polyester resin (number average molecular weight Mn=3700, glass transition temperature Tg=62° C.) and 1.0 weight parts of salicylic acid complex: predetermined weight parts of C.I. Pigment Red 122 (quinacridone, mean particle diameter: 80 to 180 nm) as a magenta coloring agent; predetermined weight parts of C.I. Pigment Red 57:1 (carmine 6B: mean particle diameter: 50 nm) having a mean particle diameter in the range of 40 to 80 nm, and a wax as a lubricant. C.I. Pigment Red 57:1 serves as a second magenta coloring agent. The wax is, for example, carnauba wax (meting point is 80° C.).

This blend was well agitated in a Henschel mixer and kneaded. After kneading, the material was heated at 120° C. for 3 hours in a roller mill and was then cooled to room temperature. The thus obtained material was crushed with the DISPERSION SEPARATOR, and then classified to obtain particles having a mean particle diameter of 8 μm.

The fourth embodiment reveals that mixing two types of pigments having different diameters, e.g., C.I. Pigment Red 122 and C.I. Pigment Red 57:1, is advantageous. A desired particle diameter can be obtained by the use of these two types of pigments. For example, C.I. Pigment Red 122 having a small particle diameter cannot be obtained while C. I. Pigment Red 57:1 having a large particle diameter. A desired particle diameter cannot be obtained by using either C.I. Pigment Red 122 or C.I. Pigment Red 57:1.

This toner was used as the toner 16 for the image forming apparatus in FIG. 1. The image forming apparatus was modified such that the high voltage supplied to the developing unit and the fixing temperature of the fixing unit 10 can be controllably changed.

The voltage applied to the developing unit was adjusted such that the toner deposited on the print paper 22 is 0.6 mg/cm². Ordinary white paper (Xerox J paper, available from Xerox) was used as the print paper 22. For different toners that have different particle diameters and a sum of C.I. Pigment Red 122 and C.I. Pigment Red 57:1 maintained at 5 weight parts, the image density p of the toner image printed on the print paper was measured with XRite 528 to find the relationship between the amount of coloring agent and image density ρ, hue, and saturation.

The image density ρ of the respective toner image on the was also examined to find the relationship between the amount of coloring agent and image density ρ, hue, and saturation for different particle diameters for two cases: (1) 5 weight part of C.I. Pigment Red 122 was used and C.I. Pigment Red 57:1 was not used, (2) 5 weight part of C.I. Pigment Red 57:1 was used and C.I. Pigment Red 122 was not used.

As shown in FIG. 3, 2-7 weight parts of the coloring agent provides good image density ρ in the range of 1.3≦ρ≦1.7, which can be accepted as normal image quality.

When the value of ρ is lower than 1.3, it is determined that the print result is not sufficiently dense and the print is blurred. When the value of ρ is higher than 1.7, it is determined that a print result is too dense and an image of half-tone has lost its details.

Table 7 lists the test results when C.I. Pigment Red 122 having a mean particle diameter of 120 nm and C.I. Pigment Red 57 having a mean particle diameter of 50 nm. Similar results were obtained for four types of C.I. Pigment Red 122 having mean particle diameters of 80 nm, 100 nm, 140 nm, and 160 nm (mean aggregate diameter: 40-800 nm), respectively. Similar results were also obtained for three types of C.I. Pigment Red 57:1 having mean particle diameters of 40 nm, 60 nm, and 80 nm (mean aggregate diameter: 40-800 nm), respectively.

TABLE 7

| quinacridone | carmine | | image | | | satura- | Inspec- |
|---|---|---|---|---|---|---|---|
| coloring | coloring | ratio | density | hue | hue | tion | tion |
| agent | agent | σ | ρ | a* | b* | cyan | magenta |
| 5 | 0 | 0.00 | 1.2 | 25.5 | −57.7 | 63 | bad |
| | | | | | | | (density |
| | | | | | | | is low) |
| 4 | 1 | 0.25 | 1.3 | 24.3 | −56.6 | 61.5 | good |
| 3 | 2 | 0.67 | 1.4 | 23 | −55.5 | 60 | good |
| 2.5 | 2.5 | 1.00 | 1.55 | 20.3 | −53.5 | 57 | good |
| 2 | 3 | 1.50 | 1.58 | 19 | −50 | 53 | good |
| 0 | 5 | — | 1.65 | 18 | −46.6 | 50 | bad |
| | | | | | | | (yellow- |
| | | | | | | | ish) |

For the toner that uses only C.I. Pigment Red 122, the image density ρ is low, so that a large amount of carnauba wax needs to be added as shown in Table 7. However, as is clear from the aforementioned first to third embodiments, adding a large amount of coloring agent causes filming to occur and the toner cost to increase. For toner that uses only C.I. Pigment Red 57:1, color development of cyan becomes poor and magenta becomes more yellowish.

From the results in Table 7, a toner that uses a blend of C.I. Pigment Red 122 and C.I. Pigment Red 57:1 requires a smaller amount of each of C.I. Pigment Red 122 and C.I. Pigment Red 57:1 than a toner that uses only C.I. Pigment Red 122. This improves the fixing margin, color development of cyan, and image quality. As a result, the cost of toner can be lowered and therefore the running cost of the image-forming apparatus can be reduced.

Good image quality can be obtained by selecting the ratio σ in the range of 0.25≦σ≦1.50 where σ is the ratio of the weight of C.I. Pigment Red 57:1 to that of C.I. Pigment Red 122.

Fifth Embodiment

Three weight parts of Pigment 15:3 (copper phthalocyanine) as a cyan coloring agent and 6 weight parts of a wax such as carnauba wax (meting point is 80° C.) as a lubricant were added to a blend of 100 weight parts of polyester resin (number average molecular weight Mn=3700, glass transition temperature Tg=62° C.) and 1.0 weight parts of salicylic acid complex.

This blend was well agitated with a Henschel mixer and kneaded. After kneading, the material was heated at 120° C. for 3 hours in a roller mill and was then cooled to room temperature. The thus obtained material was crushed with the DISPERSION SEPARATOR, and then classified to obtain particles having a mean particle diameter of 8 μm.

Two parts by weight of silica R972 was added to the surfaces of the particles, thereby obtaining a final product of toner. This toner has η=1.3, η being the ratio of population mean particle to volume mean particle diameter.

This toner was used as the toner 16 for the image-forming apparatus in FIG. 1. The image forming apparatus was modified such that the high voltage supplied to the developing unit and the fixing temperature of the fixing unit 10 can be controllably changed.

The voltage applied to the developing unit was adjusted such that the toner deposited on the print paper 22 is 0.6 mg/cm². The cleaning blade 19 in the developing unit is made of urethane rubber having a thickness of 1.8 mm. The line pressure of the cleaning blade 19 was in the range of 0.8 to 3.3 gf/mm.

The respective toners were evaluated in the following manner. The print paper 22 of a size A4 (FIG. 1) was transported in its lateral direction. A continuous printing operation of 50,000 pages was performed at a print duty of 5% and the print results were observed in terms of image quality and the filming of toner on the photoconductive drum 11. Table 8 lists the test results.

TABLE 8

| | line | volume | | | | | |
|---|---|---|---|---|---|---|---|
| | pres- | mean | | amount | | | |
| | sure- | particle | | of | | | |
| exam- | gf/ | diameter | ratio | lubri- | cleaning | | |
| ple | mm | of toner | η | cant | result | filming | results |
| 8-1 | 0.8 | 8 | 1.3 | 7 | poor | excel- | poor |
| | | | | | | lent | |
| 8-2 | 1 | 8 | 1.3 | 7 | good | excel- | excel- |
| | | | | | | lent | lent |
| 8-3 | 1.6 | 8 | 1.3 | 7 | excel- | excel- | excel- |
| | | | | | lent | lent | lent |
| 8-4 | 3 | 8 | 1.3 | 7 | excel- | good | excel- |
| | | | | | lent | | lent |
| 8-5 | 3.3 | 8 | 1.3 | 7 | excel- | poor | poor |
| | | | | | lent | | |
| 8-6 | 3 | 3 | 1.3 | 7 | poor | good | poor |
| 8-7 | 3 | 4 | 1.3 | 7 | good | good | good |
| 8-8 | 1 | 8 | 1.3 | 20 | good | good | good |
| 8-9 | 1 | 8 | 1.3 | 20 | good | poor | poor |
| 8-10 | 3 | 8 | 1.4 | 7 | good | excel- | good |
| | | | | | | lent | |
| 8-11 | 3 | 8 | 1.5 | 7 | poor | excel- | poor |
| | | | | | | lent | |

For Examples 8-1 to 8-3, 8-10, and 8-11, the image quality was good after a continuous printing operation of 50,000 pages. No foreign material was observed on the surface of the photoconductive drum 11. No filming occurred.

For Examples 8-4, 8-6, 8-7, and 8-8, only a small amount of foreign materials was observed after a continuous printing operation of about 40,000 pages but the image quality was good. After a continuous printing operation of 50,000 pages, only a small amount of foreign material was observed on the surface of the photoconductive drum 11 but the image quality was good.

For Examples 8-5 and 8-9, only a small amount of reign material was observed on the surface of the photoconductive drum 11 after a continuous printing operation of 5000 pages. After a continuous printing operation of additional 5000 pages, marks of foreign material were observed on the color image printed. The foreign material on the photoconductive drum 11 was also observed clearly by inspection. Observation of the foreign material under a TEM showed the toner deposited on the photoconductive drum. The results of infrared absorption spectrometry revealed that a large amount of toner was deposited on the photoconductive drum 11.

For Examples 8-3, 8-4, and 8-5, the color image was not deteriorated when 50,000 pages have been continuously printed. Little or no foreign material was deposited on the photoconductive material was deposited on the photoconductive drum 11, so that the color image is not affected.

For examples 8-7 to 8-10 and 8-2, vertical lines appeared on the color image when 30,000 pages have been printed. A large amount of toner was deposited in an area on the photoconductive drum corresponding to the vertical lines. It can be considered that the toner was not removed from the photoconductive drum 11 and accumulated on the charging roller 12 by the cleaning blade 19 due to deteriorated of the blade 19 and prevented the photoconductive drum 11 from being charged uniformly.

For Examples 8-1, 8-6, and 8-11, numerous elongated drip-out of toner from the printed color image were observed when 30,000 pages have been printed continuously. The marks of foreign materials having a length of about 2 to 3 mm were observed on the photoconductive drum, being elongated in a circumferential direction. Observation under a TEM showed that the toner was firmly deposited on the photoconductive drum 11.

Examples 8-2 to 8-4, 8-7, 8-8, and 8-10 showed that when the cleaning blade 19 in contact with the photoconductive drum 11 under a pressure of 0 to 3.0 gf/mm prevents filming and removes the toner thoroughly from the photoconductive drum. Thus, the image quality is improved.

The toners used in the respective embodiments are manufactured by adding inorganic fine particles and lubricants to the coloring particles that contain a binding resin, coloring agent(s), and other additives as required. The mean particle diameter of toner is in the range of 1 to 30 μm, preferably 5 to 15 μm, being expressed in volume means particle diameter.

Lubricants, which is used to increase the gloss of a printed image and reduce “offset”, include polyolefin wax, paraffin latex, microchristalline wax, polypropylene, polyethylene, or a combination of these.

The coloring agents are not limited to a particular one and may be carbon black and iron oxides used as color toners. The pigments include C.I. Pigment Blue 15:3, C.I. Pigment B15, C.I. Pigment B15:6, C.I. Pigment B68, C.I. C.I. Pigment Red 122, C.I. C.I. Pigment Red 57:1, 2,9-dimethyl quinacridone, C.I. Pigment Yellow 17, C.I. Pigment Y81, C.I. Pigment Y154, and Pigment Y 185.

Other additives include inorganic fine particles of silica, titanium oxide, aluminum oxide, barium titanate, strontium titanate, which have population mean particle in the range of 5 to 1000 nm. These may be hydrophobic.

The toner may contain a cleaning aid, for example, fine particles of styrene acrylic resin particle or higher fatty acid metallic salts such as zinc stearate, the cleaning aid having a population means particle in the range of 0.1 to 2.0 μm. The proportion of added inorganic fine particles to the coloring particles is preferably in the range of 0.1 to 2.0 weight percent. The proportion of the cleaning aid to the coloring particles is preferably in the range of 0.01 to 1.0 weight percent.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A developer comprised of:
a resin material;
a colorant; and
a lubricant;
wherein a ratio of a weight part of said lubricant to a weight part of said colorant is in the range of 0.3 to 10.0.

2. The developer according to claim 1, wherein a ratio of a weight of said lubricant to a weight of said colorant is in the range of 0.5 to 2.5.

3. The developer according to claim 1, wherein said lubricant has a melting point in the range of 55 to 85° C.

4. The developer according to claim 1, wherein a ratio of a weight of said lubricant to a weight of said colorant is in the range of 1.0 to 5.

5. The developer according to claim 1, wherein said lubricant has a melting point in the range of 55 to 85° C.

6. The developer according to claim 1, wherein a ratio of a weight of said lubricant to a weight of said colorant is in the range of 0.3 to 2.0.

7. The developer according to claim 1, wherein said lubricant has a melting point in the range of 55 to 85° C.

8. A developer cartridge that holds the developer according to claim 1.

9. A developer comprised of:
a resin material;
a colorant; and
a lubricant;
wherein said colorant has either a mean particle diameter in the range of 20 to 50 nm or a mean aggregate diameter in the range of 20 to 600 nm;
wherein a ratio of a weight of said lubricant to a weight of said colorant in the range of 0.5 to 5.0.

10. The developer according to claim 9, wherein a ratio of a weight of said lubricant to a weight of said colorant is in the range of 0.5 to 2.5.

11. The developer according to claim 9, wherein said lubricant has a melting point in the range of 55 to 85° C.

12. A developer cartridge that holds the developer according to claim 9.

13. A developer comprised of:
a resin material;
a colorant; and
a lubricant;
wherein said colorant has a mean particle diameter in the range of 40 to 80 nm and a mean aggregate diameter in the range of 40 to 800 nm;
wherein a ratio of a weight part of said lubricant to a weight part of said colorant is in the range of 0.3 to 10.0.

14. The developer according to claim 13, wherein a ratio of a weight of said lubricant to a weight of said colorant is in the range of 1.0 to 5.

15. The developer according to claim 13, wherein said lubricant has a melting point in the range of 55 to 85° C.

16. A developer comprised of:
a resin material;
a colorant; and
a lubricant;
wherein said colorant has a mean particle diameter in the range of 80 to 180 nm and a mean aggregate diameter in the range of 80 to 1000 nm;
wherein a ratio of a weight of said lubricant to a weight part of said colorant is in the range of 0.3 to 4.0.

17. The developer according to claim 16, wherein a ratio of a weight of said lubricant to a weight of said colorant is in the range of 0.3 to 2.0.

18. The developer according to claim 16, wherein said lubricant has a melting point in the range of 55 to 85° C.

19. A developer comprised of:
a resin material;
a colorant; and
a lubricant;
wherein said colorant is obtained by blending two types of pigments that are different in mean particle diameter and mean aggregate diameter.

20. The developer according to claim 19, wherein a first one of the two types of pigments has a mean particle diameter in the range of 80 to 180 nm or a mean aggregate diameter in the range of 80 to 1000 nm;
wherein a second one of the two types of pigments has a mean particle diameter in the range of 40 to 80 nm or a mean aggregate diameter in the range of 40 to 800 nm.

21. The developer according to claim 19, a first one of the two types of pigments has a larger mean particle diameter or a larger mean aggregate diameter than a second one of the two types of pigments;
wherein a ratio of a weight of the first one of the two types of pigments to a weight of the second one of the two types of pigments is in the range of 0.5 to 1.5.

22. An image forming apparatus incorporating a developer cartridge according to claim 12,
wherein the image forming apparatus includes:
an image bearing body;
a charging unit that charges said image bearing body;
an exposing unit that forms an electrostatic latent image on said image bearing body charged by said charging unit;
a developing unit that develops the electrostatic latent image with a developer held in the developer cartridge into a visual image;
a transferring unit that transfers the visual image onto a print medium; and
a fixing unit that fixes the visual image on the print medium.

23. An image forming apparatus comprising:
an image bearing body;
a charging unit that charges said image bearing body;
an exposing unit that forms an electrostatic latent image on said image bearing body charged by said charging unit;
a developing unit that develops the electrostatic latent image with a developer into a visual image;
a transferring unit that transfers the visual image onto a print medium; and
a cleaning member in contact with said image bearing body to remove the developer remaining on said image bearing body after the visual image has been transferred onto the print medium;
wherein said cleaning member is pressed against said image bearing body under a line pressure in the range of 0.3 to 3.0 gf/mm.

24. An image forming apparatus according to claim 23, wherein the image forming apparatus incorporates the developer cartridge according to claim 14.

25. A developer cartridge that holds the developer according to claim 13.

26. An image forming apparatus incorporating a developer cartridge according to claim 25,
wherein the image forming apparatus includes:
an image bearing body;
a charging unit that charges said image bearing body;
an exposing unit that forms an electrostatic latent image on said image bearing body charged by said charging unit;
a developing unit that develops the electrostatic latent image with a developer held in the developer cartridge into a visual image;
a transferring unit that transfers the visual image onto a print medium; and
a fixing unit that fixes the visual image on the print medium.

27. A developer cartridge that holds the developer according to claim 16.

28. An image forming apparatus incorporating a developer cartridge according to claim 27,
wherein the image forming apparatus includes:
an image bearing body;
a charging unit that charges said image bearing body;
an exposing unit that forms an electrostatic latent image on said image bearing body charged by said charging unit;
a developing unit that develops the electrostatic latent image with a developer held in the developer cartridge into a visual image;
a transferring unit that transfers the visual image onto a print medium; and
a fixing unit that fixes the visual image on the print medium.

29. A developer cartridge that holds the developer according to claim 19.

30. An image forming apparatus incorporating a developer cartridge according to claim 29,
wherein the image forming apparatus includes:
an image bearing body;
a charging unit that charges said image bearing body;
an exposing unit that forms an electrostatic latent image on said image bearing body charged by said charging unit;
a developing unit that develops the electrostatic latent image with a developer held in the developer cartridge into a visual image;
a transferring unit that transfers the visual image onto a print medium; and
a fixing unit that fixes the visual image on the print medium.

31. An image forming apparatus incorporating a developer cartridge according to claim 8,
wherein the image forming apparatus includes:
an image bearing body;
a charging unit that charges said image bearing body;
an exposing unit that forms an electrostatic latent image on said image bearing body charged by said charging unit;
a developing unit that develops the electrostatic latent image with a developer held in the developer cartridge into a visual image;
a transferring unit that transfers the visual image onto a print medium; and
a fixing unit that fixes the visual image on the print medium.
